(19) United States
(12) Patent Application Publication
(10) Pub. No.: US 2010/0201734 A1
(43) Pub. Date: Aug. 12, 2010

(54) INKJET PRINTER HAVING ARRAY TYPE HEAD AND METHOD OF DRIVING THE SAME

(75) Inventor: Keon KUK, Yongin-Si (KR)

Correspondence Address: DLA PIPER LLP US, P. O. BOX 2758, RESTON, VA, 20195, US

(73) Assignee: SAMSUNG ELECTRONICS CO., LTD., Suwon-Si (KR)

(21) Appl. No.: 12/557,984

(22) Filed: Sep. 11, 2009

(30) Foreign Application Priority Data
Feb. 12, 2009 (KR) 10-2009-0011503

(51) Int. Cl. B41J 29/38; B41J 2/175

(52) U.S. Cl. 347/17; 347/85

(57) ABSTRACT

Provided is an inkjet printer having an array type head and a method of operating the inkjet printer. The inkjet printer can include a cartridge, a reservoir, a comparator and a pump. The cartridge can have an array type head with multiple inkjet printheads and a manifold to supply ink to the inkjet printheads. Each inkjet printhead can have a temperature sensor to measure temperature. The comparator can compare a signal produced by each of the temperature sensors to a signal associated with a reference temperature. The pump can circulate ink between the reservoir and the manifold of the cartridge based on the result of the temperature comparison.

### CROSS-REFERENCE TO RELATED PATENT APPLICATION

This application claims the benefit of Korean Patent Application No. 10-2009-0011503, filed on Feb. 12, 2009, in the Korean Intellectual Property Office, the disclosure of which is incorporated herein by reference in its entirety.

### TECHNICAL FIELD

The present disclosure generally relates to an inkjet printer, and more particularly, to an inkjet printer having an array type head, and to a method of driving the inkjet printer.

### BACKGROUND OF RELATED ART

An inkjet printer is a device capable of forming a predetermined color image by ejecting small ink droplets on desired areas of a printing medium through nozzles of an inkjet printhead. Inkjet printers can generally be of two types: a shuttle type inkjet printer, in which a printing operation is performed while an inkjet printhead is reciprocally moving typically perpendicular to the moving direction of a printing medium, and a line printing type inkjet printer, which has been recently developed to operate at higher printing speed, and which has an array type head having an array size corresponding to the width of a printing medium. In the array type head of the line printing type inkjet printer, multiple inkjet printheads can be arranged in a predetermined manner along a width direction of the printing medium. The line printing type inkjet printer can achieve high speed printing because the array type head can be stationary while the printing operation is performed by moving the printing medium. The array type head in some cases can have a size smaller than the width of the printing medium.

The printheads of an inkjet printer can also be generally classified into two types according to the mechanism used to eject the ink droplets. The first type is a thermal inkjet printhead that ejects ink droplets using the expansion force of ink bubbles created using a heat source. The second type is a piezoelectric inkjet printhead that ejects inkjet droplets using a pressure created by the deformation of a piezoelectric element. An ink droplet ejection mechanism in a thermal inkjet printhead is described below in more detail. When a pulse type current is applied to a heater formed of a resistive heating element, heat is generated from the heater and ink adjacent to the heater is instantly heated to approximately 300 Celsius (° C.). As a result of the heat applied, the ink boils, generating ink bubbles. The expansion of the ink bubbles applies pressure to the ink filled in an ink chamber causing the ink adjacent to the nozzles to be ejected from the ink chamber through the nozzle in the form of droplets.

In line printing type inkjet printers, because multiple inkjet printheads are arranged in a width direction of a printing medium, when a predetermined pattern is repeatedly printed, heat can accumulate in the inkjet printheads located in a particular region. The heat produced can adversely affect the printing speed, and can also cause the characteristics of nozzles between the inkjet printheads to vary, thereby causing the ejection characteristic of the nozzles to be non-uniform.

### SUMMARY OF THE DISCLOSURE

According to an aspect of the present disclosure, there is provided an inkjet printer that can include a cartridge, a reservoir, a comparator, and a pump. The cartridge may include a plurality of inkjet printheads arranged in an array, a manifold configured to supply ink to the plurality of inkjet printheads and one or more temperature sensors configured to sense one or more temperatures respectively of one or more of the plurality of inkjet printheads. The reservoir may define a volume in which to store ink. The comparator may be configured to compare the one or more temperatures sensed by of the one or more temperature sensors with a reference temperature. The pump may be configured to circulate ink between the reservoir and the manifold of the cartridge, the pump being configured to operate based on the comparison of temperatures by the comparator.

The pump may be configured to operate when the one or more temperatures as measured by the one or more temperature sensors is higher than the reference temperature.

The reservoir may be in a fluid communication with both ends of the manifold of the cartridge. The pump may be disposed at a location along the fluid communication path between the reservoir and the manifold.

The plurality of inkjet printheads may be arranged along a width direction of a printing medium.

The cartridge may be configured to be stationary while a printing medium moves relative to the cartridge during a printing operation.

The array in which the plurality of inkjet printheads are arranged has one dimension that substantially corresponds to the width of the printing medium.

According to another aspect, a method of operating an inkjet printer having an ink cartridge that includes a plurality of inkjet printheads may be provided to include the steps of performing a printing operation; determining whether a temperature of one or more of the plurality of inkjet printheads exceeds a reference temperature; and circulating ink through the ink cartridge upon determination of the temperature of one or more of the plurality of inkjet printheads exceeding the reference temperature.

The step of determining may comprise measuring the temperature at each of the plurality of inkjet printheads during the printing operation; and comparing the measured temperatures to the reference temperature. The step of circulating ink may comprise circulating ink from an ink reservoir through the ink cartridge when the measured temperatures of at least one of the plurality of inkjet printheads is higher than the reference temperature.

the step of circulating ink may further comprise providing a pump configured to pump ink stored in an ink reservoir through an ink supply path to the ink cartridge; and operating the pump upon determination of the temperature of one or more of the plurality of inkjet printheads exceeding the reference temperature.

The step of performing the printing operation may comprise moving a printing medium relative to the plurality of inkjet printheads that is kept stationary, the plurality of inkjet printheads being arranged in an array that substantially spans a width of the printing medium.

The step of measuring the temperature may comprise receiving an output signal from a temperature sensor provided on each of the plurality of inkjet printheads.

The step of determining may further comprise comparing with a comparator the received output signal with a reference signal that corresponds to the reference temperature.

The step of circulating ink may comprise providing a pump configured to pump ink stored in the ink reservoir through an ink supply path to the ink cartridge; and sending by the comparator a signal to the pump, the signal causing the pump to start operating.

The step of circulating ink may be performed without stopping the printing operation.

According to yet another aspect, an inkjet printer may be provided to include an ink cartridge and a pump. The ink cartridge may include a plurality of inkjet printheads and a manifold configured to supply received ink to the plurality of inkjet printheads. The manifold may have an inlet through which ink is received into the manifold and an outlet through which ink exits from the manifold. The pump may be configured to move ink such that an amount of ink received through the inlet into the manifold moves towards and exits from the outlet of the manifold.

The pump may be configured to be in one of an operating mode and a non-operating mode, the pump being operable to cause a movement of ink when the pump is in the operating mode, no movement of ink being caused by the pump when the pump is in the non-operating mode. The inkjet printer may be configured to operate the pump selectively in one of the operating mode and the non-operating mode based on a temperature of one or more of the plurality of inkjet printheads.

The ink cartridge may be configured to operate in a stationary position.

The inkjet printer may be configured to operate the pump selectively in the operating mode in response to the temperature of one or more of the plurality of inkjet printheads exceeding a reference temperature.

The inkjet printer may further comprise a plurality of temperature sensors and a comparator. The plurality of temperature sensors may each be associated with a respective corresponding one of the plurality of inkjet printheads, and may each of be configured to output a sensed signal indicative of a temperature of the associated one of the plurality of inkjet printheads. The comparator may be configured to receive one or more sensed signals output by one or more of the plurality of temperature sensors and to compare the received one or more sensed signal with a reference signal indicative of the reference temperature.

The comparator may be configured to output a control signal based upon a result of the comparison of the received one or more sensed signal with the reference signal. The control signal may cause the pump to switch from being in the non-operating mode to being in the operating mode.

### BRIEF DESCRIPTION OF THE DRAWINGS

Various features and advantages of the present disclosure will become more apparent by describing in detail several embodiments thereof with reference to the attached drawings, in which:

FIG. 1 is a plan view showing a printing operation of a conventional array type head;

FIG. 2 is a schematic drawing of an inkjet printer having an array type head according to an embodiment of the present disclosure;

FIG. 3 is a graph showing the temperature variation of an inkjet printhead versus printing time after printing two pages of a document with a conventional natural cooling method;

FIG. 4 is a graph showing the temperature variation of an inkjet printhead versus printing time after printing two pages of a document in a conventional spitting method; and

FIG. 5 is a graph showing the temperature variation of an inkjet printhead according to printing time using ink circulation according to an embodiment of the present disclosure.

### DETAILED DESCRIPTION OF SEVERAL EMBODIMENTS

The present disclosure is described below more fully with reference to the accompanying drawings, in which several embodiments of the present disclosure are shown. In the drawings, the thicknesses of layers and regions are exaggerated for clarity, and like reference numerals refer to the like elements. The various embodiments of the present disclosure described below are provided by way of example and can be modified in many different forms.

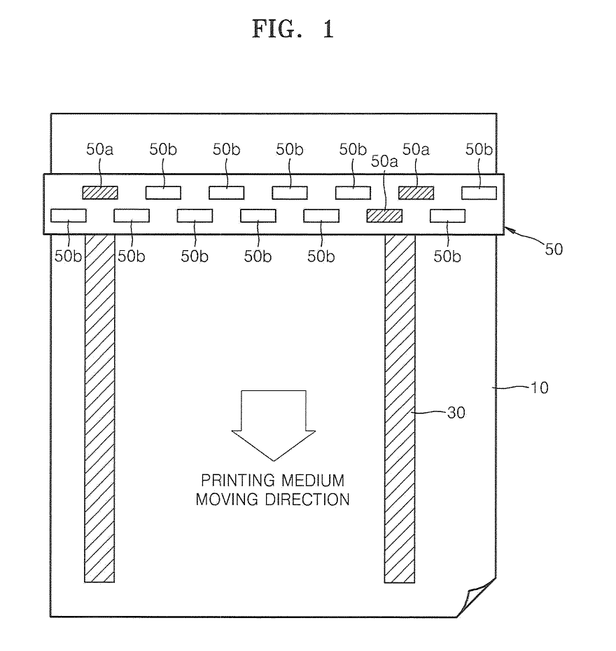

FIG. 1 is a plan view showing a printing operation of a conventional array type head 50. Referring to FIG. 1, the array type head 50 can include multiple inkjet printheads 50a and 50b, and can have a size corresponding to the width of the printing medium 10. The inkjet printheads 50a and 50b can be arranged or configured in a predetermined manner along the width direction of the printing medium 10. The array type head 50 can perform the printing operation without moving while only the printing medium 10 moves. Unlike a shuttle type inkjet printer that performs the printing operation by reciprocally moving the inkjet printheads when a specific predetermined pattern 30 is repeatedly printed on the printing medium 10, such as, for example, the pattern shown in FIG. 1, when the array type head 50 is fixed, multiple predetermined inkjet printheads (e.g., inkjet printheads 50a) can overheat to a temperature at which the printing operation may no longer be performed properly or at all.

In this example, the inkjet printheads 50a in the array type head 50, which are heated as a result of the type of pattern printed, must be cooled by stopping the printing operation until the temperature of the inkjet printheads 50a can be reduced to a temperature that allows the printing operation to resume. Such an approach, however, can greatly reduce printing speed. Another approach can be to cool down the inkjet printheads 50a by performing a low frequency spitting operation after stopping the printing operation of the inkjet printheads 50a. In this approach, the inkjet printheads 50a can be cooled faster than by using the natural cooling method described above. This approach, however, can nevertheless still make it difficult to achieve a desirable printing speed of an array type head designed for high speed printing. To address some of the limitations described above, according to an aspect of the present disclosure, there are provided an inkjet printer having an array type head that can achieve high speed printing by cooling inkjet printheads by circulating ink in an ink-reservoir and a method of driving the inkjet printer.

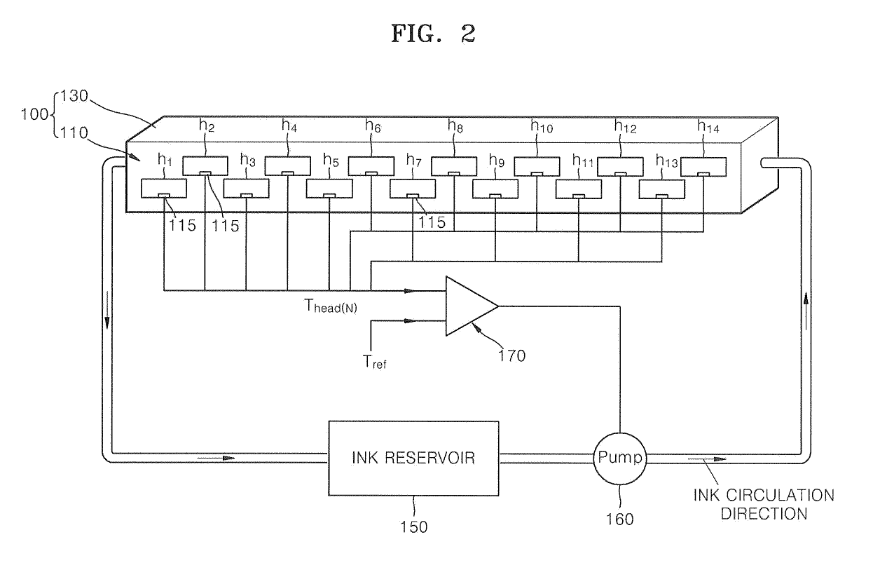

FIG. 2 is a schematic drawing of an inkjet printer having an array type head according to an embodiment of the present disclosure.

Referring to FIG. 2, the inkjet printer can include an ink cartridge 100 having an array type head 110, an ink-reservoir 150 configured to supply ink to the ink cartridge 100, and a circulation pump 160 configured to circulate the ink from the ink-reservoir 150 to the ink cartridge 100.

The array type head 110 can include multiple inkjet printheads arranged in a predetermined manner in the width direction of a printing medium. In the embodiment shown in FIG. 2, the array type head 110 can have fourteen inkjet printheads h1 through h14, which can be arranged in a staggered fashion in two rows along the width direction of the printing medium. For example, the inkjet printheads h1, h3, h5, h6, h9, h11, and h13 can be in a first row, while the inkjet printheads h2, h4, h6, h8, h10, h12, and h14 can be in a second row. It should be noted however that the present disclosure need not be limited to the arrangement shown in FIG. 2, and that other embodiments of inkjet printheads can have different arrangements or configurations. Each of the inkjet printheads h1 through h14 can include one or more nozzles (not shown) to eject ink and a temperature sensor 115 configured to measure the temperature associated with the inkjet printhead. In one embodiment, the array type head 110 can have a size that correspond to the width of the printing medium. In other embodiments, however, the array type head 110 can have a size smaller than the width of the printing medium. According to an embodiment of the present disclosure, the printing operation can be performed by moving the printing medium while the array type head 110 remains stationary.

The ink cartridge 100 can further include a manifold 130 configured to supply ink. The manifold 130 can be configured to supply ink to each of the inkjet printheads h1 through h14 of the array type head 110. The ink-reservoir 150 can store the ink to be supplied to the manifold 130 and can be in fluid communication with both ends of the manifold 130 of the ink cartridge 100 by, for example, a tube. The circulation pump 160, which is configured to circulate ink between the ink-reservoir 150 and the manifold 130, can be installed along any portion of the tube connecting the ink-reservoir 150 and the manifold 130.

The inkjet printer can further include a comparator 170 configured to compare signals that are representative of the temperatures of the inkjet printheads h1 through h14, T_{head(N)} where N=1, . . . , 14, to a signal representative of a reference temperature T_{ref}. The reference temperature T_{ref} can be, for example, a temperature that is known, through calculations, simulations, and/or by empirical data, to allow the printing operation to be performed. One input of the comparator 170 can be connected to the temperature sensors 115 of the inkjet printheads h1 through h14 to compare signals representative of the temperatures T_{head(N)} of the inkjet printheads h1 through h14 measured during the printing operation to the signal representative of the reference temperature T_{ref}. When at least one of the measured temperatures T_{head(N)} is determined to have a temperature that is higher than the reference temperature T_{ref}, the circulation pump 160 may start operating.

A method of driving the inkjet printer having the above configuration is described below.

A printing operation can be performed by ejecting ink from one or more of the inkjet printheads h1 through h14 of the array type head 110. The array type head 110 can have a size corresponding to the width of a printing medium, and the printing operation can be performed by moving the printing medium while the array type head 110 is stationary. During the printing operation, when heat accumulates on certain of the inkjet printheads h1 through h14, the temperature of those inkjet printheads, and possibly the temperature of some of the nearby inkjet printheads, may increase. The temperature of each of the inkjet printheads h1 through h14 can be measured by the temperature sensor 115 attached to the inkjet printheads. The signals produced by the temperature sensor 115 in response to the measured temperatures T_{head(N)} of the inkjet printheads h1 through h14 can be compared to the signal representative of the reference temperature T_{ref} of the comparator 170. In some embodiments, for example, the signal output from the temperature sensor 115 can be proportional to the measured temperature. When, as a result of the comparison, it is determined that at least one of the measured temperatures T_{head(N)} of the inkjet printheads h1 through h14 is higher than the reference temperature T_{ref}, the comparator 170 can send a signal to the circulation pump 160 to start operating. When the circulation pump 160 starts operating, the ink in the ink-reservoir 150 can be circulated into the manifold 130 of the ink cartridge 100. The manifold 130 can be attached to the inkjet printheads h1 through h14 to supply ink to each of the inkjet printheads h1 through h14. Therefore, when ink stored in the ink-reservoir 150, which may be at a relatively low temperature, is circulated through the manifold 130, those inkjet printheads h1 through h14 that are heated during of the printing operation can be rapidly cooled down, allowing the printing operation to continue.

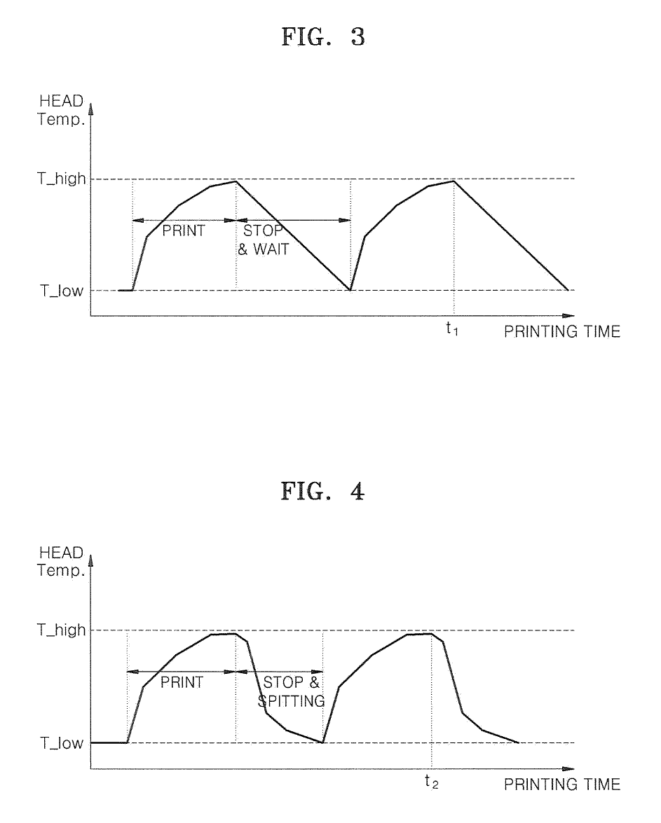

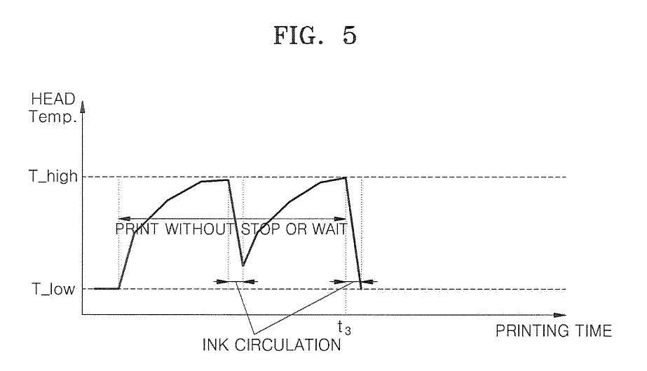

FIGS. 3-5 are graphs showing the temperature variation of an inkjet printhead versus time when printing a document with various ways in which to cool the inkjet printhead. More specifically, FIG. 3 is a graph showing the temperature variation of an inkjet printhead versus printing time after printing the first and second pages of a document using a conventional waiting approach. FIG. 4 is a graph showing the temperature variation of an inkjet printhead versus printing time after printing the first and second pages of a document using a conventional spitting approach. FIG. 5 is a graph showing the temperature variation of an inkjet printhead versus printing time using ink circulation according to an embodiment of the present disclosure.

Referring to FIG. 3, after the first page of the document is printed, the printing operation is stopped for a period of time until the temperature of the inkjet printhead is naturally cooled down to a permissible low printing temperature T_low. Once the low printing temperature T_low is reached, the second page of the document can be printed. In this example, the total time for printing the first and second pages is t₁. Referring to FIG. 4, after the first page of document is printed, the printing operation is stopped for a period of time until the temperature of the inkjet printhead is reduced to a permissible low printing temperature T_low using a low frequency spitting approach. After the low printing temperature T_low is reached, the second page of the document can be printed. In this example, the total time for printing the first and second pages is t₂, where the time t₂ is shorter than the time t₁.

Referring to FIG. 5, according to an embodiment of the present disclosure, when the temperature of the inkjet printhead is higher than the reference temperature, ink in the ink-reservoir can circulate through the manifold, as described above. As a result of such ink circulation, the heated inkjet printhead can be rapidly cooled, and accordingly, the printing operation can be continued during the circulation of the ink. Thus, as shown in FIG. 5, the time for printing the first and second pages can be reduced to t₃, where the time t₃ is shorter than the time t₂.

As described above, according to an embodiment of the present disclosure, the printing operation can be continued without the need of waiting until the heated inkjet printheads of the array type head are cooled to a permissible low printing temperature, which allows the realization of high speed printing operations. Also, according to an embodiment, the inkjet printheads can be rapidly cooled by using ink having high thermal capacity from an ink-reservoir without the need of an additional cooling device. Also, since the temperature of each of the inkjet printheads that constitute an array type head can be made substantially uniform, the ejection characteristic of each of the inkjet printheads can be maintained uniform.

While the present disclosure has been particularly shown and described with reference to several embodiments thereof, it will be understood by those of ordinary skill in the art that various changes in form and details may be made therein without departing from the spirit and scope of the present disclosure as defined by the following claims.

What is claimed is:

1. An inkjet printer, comprising:
a cartridge having a plurality of inkjet printheads arranged in an array, a manifold configured to supply ink to the plurality of inkjet printheads and one or more temperature sensors configured to sense one or more temperatures respectively of one or more of the plurality of inkjet printheads;
a reservoir defining a volume in which to store ink;
a comparator configured to compare the one or more temperatures sensed by of the one or more temperature sensors with a reference temperature; and
a pump configured to circulate ink between the reservoir and the manifold of the cartridge, the pump being configured to operate based on the comparison of temperatures by the comparator.

2. The inkjet printer of claim 1, wherein the pump is configured to operate when the one or more temperatures as measured by the one or more temperature sensors is higher than the reference temperature.

3. The inkjet printer of claim 2, wherein the reservoir is in a fluid communication with both ends of the manifold of the cartridge, and
wherein the pump is disposed at a location along the fluid communication path between the reservoir and the manifold.

4. The inkjet printer of claim 1, wherein the plurality of inkjet printheads are arranged along a width direction of a printing medium.

5. The inkjet printer of claim 1, wherein the cartridge is configured to be stationary while a printing medium moves relative to the cartridge during a printing operation.

6. The inkjet printer of claim 5, wherein the array in which the plurality of inkjet printheads are arranged has one dimension that substantially corresponds to the width of the printing medium.

7. An inkjet printer, comprising:
an ink cartridge that includes a plurality of inkjet printheads and a manifold configured to supply received ink to the plurality of inkjet printheads, the manifold having an inlet through which ink is received into the manifold and an outlet through which ink exits from the manifold; and
a pump configured to move ink such that an amount of ink received through the inlet into the manifold moves towards and exits from the outlet of the manifold.

8. The inkjet printer according to claim 7, wherein the pump is configured to be in one of an operating mode and a non-operating mode, the pump being operable to cause a movement of ink when the pump is in the operating mode, no movement of ink being caused by the pump when the pump is in the non-operating mode, and
wherein the inkjet printer is configured to operate the pump selectively in one of the operating mode and the non-operating mode based on a temperature of one or more of the plurality of inkjet printheads.

9. The inkjet printer according to claim 8, wherein the ink cartridge is configured to operate in a stationary position.

10. The inkjet printer according to claim 9, wherein the inkjet printer is configured to operate the pump selectively in the operating mode in response to the temperature of one or more of the plurality of inkjet printheads exceeding a reference temperature.

11. The inkjet printer according to claim 10, further comprising:
a plurality of temperature sensors each associated with a respective corresponding one of the plurality of inkjet printheads, each of the plurality of temperature sensors being configured to output a sensed signal indicative of a temperature of the associated one of the plurality of inkjet printheads; and
a comparator configured to receive one or more sensed signals output by one or more of the plurality of temperature sensors and to compare the received one or more sensed signal with a reference signal indicative of the reference temperature.

12. The inkjet printer according to claim 11, wherein the comparator is configured to output a control signal based upon a result of the comparison of the received one or more sensed signal with the reference signal, the control signal causing the pump to switch from being in the non-operating mode to being in the operating mode.
